(19) United States
(12) Patent Application Publication
(10) Pub. No.: US 2016/0192322 A1
(43) Pub. Date: Jun. 30, 2016

(54) SELECTIVELY NOTIFYING USERS OF INCOMING MESSAGES ON A SECONDARY ELECTRONIC DEVICE

(71) Applicant: EBAY INC., San Jose, CA (US)

(72) Inventor: David Edward Eramian, San Jose, CA (US)

(21) Appl. No.: 14/584,047

(22) Filed: Dec. 29, 2014

(51) Int. Cl. H04W 68/02; H04W 4/12

(52) U.S. Cl. CPC H04W 68/02; H04W 4/12

(57) ABSTRACT

The present disclosure involves selectively and intelligently notifying a user of electronic messages via a secondary electronic device communicatively coupled to a primary electronic device. The secondary electronic device may be a wearable electronic device or an automobile, and the primary electronic device may be a smartphone or a tablet. An electronic link is established between the primary electronic device and the secondary electronic device. According to a list of filter criteria, a determination is made as to whether information about the one or more electronic messages should be pushed by the primary electronic device to the secondary electronic device immediately, at a later point in time, or not at all. Based on the determination made, information about the one or more electronic messages is selectively pushed to the secondary electronic device

### BACKGROUND

1. Technical Field

The present disclosure generally relates to electronic communication, and more particularly, to selectively notifying users of the arrival of electronic messages on a second electronic device that is communicatively coupled to a first electronic device.

2. Related Art

Wearable electronic devices such as smartwatches or head-mounted displays have been gaining popularity recently. Compared to primary portable computing devices such as smartphones or tablet computers, these wearable electronic devices are typically significantly cheaper and smaller but have limited functionality. For example, these wearable electronic devices usually rely on a communications link with a smartphone or tablet computer to retrieve electronic messages such as emails or texts for the user. However, due to the small screen sizes of the wearable electronic devices, the screen can quickly become cluttered as more and more messages arrive. Typically, the user may be only interested in seeing some of these messages right away, while other messages can be delayed or not pushed through to the wearable electronic device at all. Unfortunately, conventional wearable electronic devices are not sophisticated enough to recognize how the user should be notified of the arrival of some of the messages but not others.

### BRIEF DESCRIPTION OF THE DRAWINGS

FIG. 1 is a simplified block diagram illustrating a system that includes a primary electronic device and a plurality of secondary electronic devices according to embodiments of the present disclosure.

FIG. 2 is a simplified block diagram illustrating how various electronic messages are filtered by a filter module in an electronic device so as to determine how a user should be notified of the arrival of each of the messages according to embodiments of the present disclosure.

FIGS. 3-4 are example flowcharts of methods of selectively notifying a user of electronic messages according to various embodiments of the present disclosure.

FIG. 5 is an example computer system for implementing the various steps of the methods of FIGS. 3-4 according to various embodiments of the present disclosure.

FIG. 6 is a simplified example of a cloud-based computing architecture according to various embodiments of the present disclosure.

FIG. 7 is a simplified block diagram of an electronic system for implementing various methods and devices described according to various embodiments of the present disclosure.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting. Various features may be arbitrarily drawn in different scales for simplicity and clarity.

Rapid advances in computer technology and telecommunications have made mobile electronic devices such as smartphones and tablet computers ubiquitous in everyday life. Among other things, these mobile electronic devices can be used to browse the web, send and receive emails and text messages, take pictures or record videos, play multimedia content such as movies or music, play games, etc. However, tablet computers are typically too big (e.g., screen sizes between 6-10 inches and weighing between 0.5-2 pounds) for a user to constantly carry around. As smartphone sizes have been steadily increasingly recently—most smartphones now have screens that are greater than 4.5 inches—the same may be said about smartphones as well.

Wearable electronic devices have been introduced commercially at least in part to address the portability limitations of smartphones and tablet computers. For instance, smartwatches (SAMSUNG GEAR®), head-mounted displays (e.g., GOOGLE GLASS®), or smart fitness bands (e.g., FITBIT®) are example types of wearable electronic devices. Due to their small sizes, a wearable electronic device can be easily worn by its user for a long period of time without causing discomfort for the user. The wearable electronic device may also be communicatively coupled (i.e., “tethered”) to its user's smartphone or tablet computer. In this manner, once the smartphone or tablet computer receives electronic messages such as emails or texts, these electronic messages can be pushed to the wearable electronic device, in which case the user may choose to view the messages either on the wearable electronic device or on the smartphone/tablet computer. It may be said that the smartphone or tablet computer is a primary electronic device for a user, while the wearable electronic device is a secondary electronic device communicatively coupled to the primary electronic device. Note that the designation of primary and secondary devices may be up to the user and/or the service provider, and more generally, embodiments described herein are directed to communication and interaction between two or more user devices, and a primary device can be viewed as the device receiving a message and a secondary device can be viewed as the device receiving a notification or message from the primary device regarding the message.

Under this scheme, although it is convenient for the user to receive electronic messages without having to pull out his/her smartphone or tablet, the small screen real estate of the wearable electronic devices may present other complications. For example, if the user has a very active work or social life, he/she may be constantly receiving electronic messages. If all these electronic messages are pushed from the smartphone/tablet computer to the wearable electronic device, the relatively small screen (e.g., typically less than 2 inches) of the wearable electronic device may become cluttered with notifications, which may frustrate the user.

In some situations, an automobile—though technically not a wearable electronic device—can also be considered as a secondary electronic device, since it can be communicatively coupled to a primary electronic device such as a smartphone or tablet computer. In that case, the electronic messages may be pushed from the smartphone or tablet computer to the navigation panel (or some place on the dashboard) of the automobile.

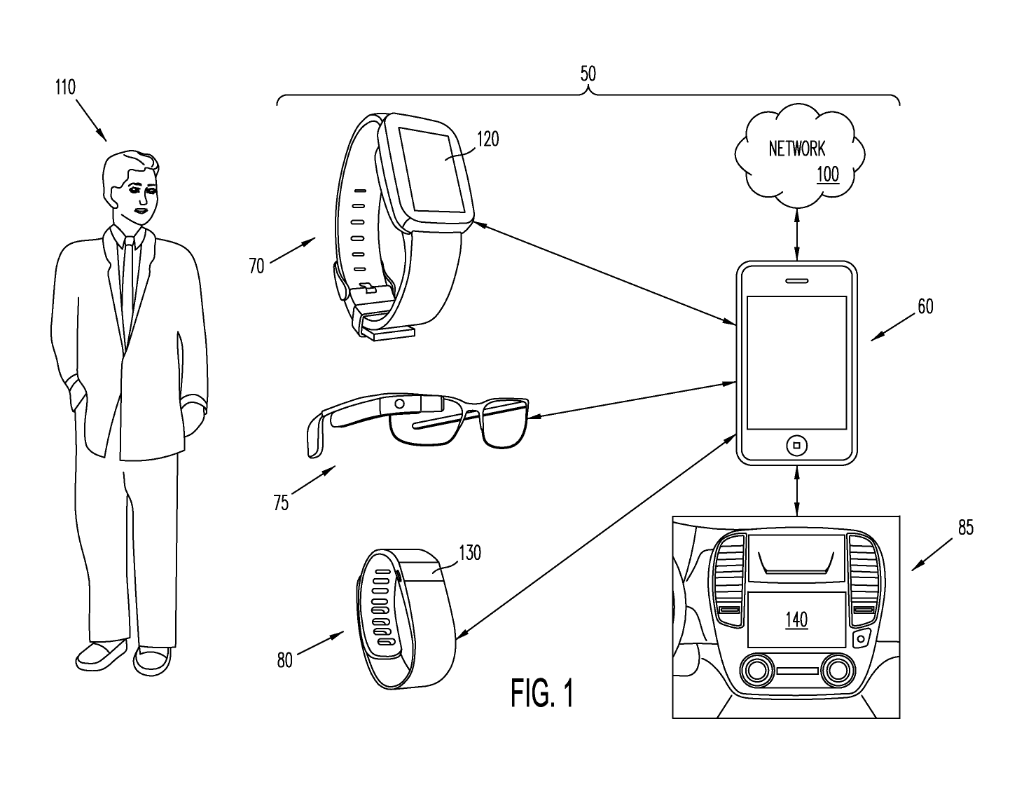

The present disclosure offers an improved way to selectively and intelligently communicate electronic messages to the user of a secondary electronic device, which is discussed in detail below with reference to FIGS. 1-7.

FIG. 1 is a simplified high-level block diagram view of a system 50 in accordance with various aspects of the present disclosure. The system 50 includes a primary electronic device 60 and a plurality of secondary electronic devices, for example secondary electronic devices 70, 75, 80, and 85. In various embodiments, the primary electronic device 60 may include a smartphone (e.g., the APPLE IPHONE® or phones powered by operating systems such as ANDROID®, WINDOWS®, BLACKBERRY®, etc.), or a tablet computer (e.g., the APPLE IPAD® or tablets powered by operating systems such as ANDROID®, WINDOWS®, BLACKBERRY®, etc.). In other embodiments, the primary electronic device 60 may include a laptop computer or a desktop computer instead of, or in addition to, the smartphone or tablet computer.

The primary electronic device 60 is communicatively coupled to a network 100, for example the Internet or an Intranet such as a company or home communications network. Through the network 100, the primary electronic device 100 receives electronic messages for a user 110 of the primary electronic device 100. These electronic messages may include, but are not limited to, emails, text messages, offers, coupons, app notifications, discounts, multimedia messages, electronic reminders for tasks/appointments, weather updates, traffic conditions, scores for sporting events, stock quotes, battery status, or other notifications. When one of these electronic messages is received, the primary electronic device 60 may push or forward the message to one or more of the secondary electronic devices 70-85 communicatively coupled thereto.

In the embodiment shown in FIG. 1, the secondary electronic device 70 is a smartwatch (e.g., SAMSUNG GEAR®), the secondary electronic device 75 is a head-mounted display (e.g., GOOGLE GLASS®), the secondary electronic device 80 is a fitness band (e.g., FITBIT®), and the secondary electronic device 85 is an automobile. These secondary electronic devices 70-85 each have a radio component that includes a transceiver or a receiver and a transmitter. Via their respective radio components, the secondary electronic devices 70-85 may establish wireless or wired communications links with the primary electronic device 60 and conduct telecommunications with the primary electronic device 60 accordingly. For example, the primary electronic device 60 may be able to push or forward electronic messages to one or more of the secondary electronic devices 70-85.

The secondary electronic devices 70-85 each have their own communication interfaces. For example, the secondary electronic device 70 includes a display screen 120 as a part of its communications interface, the secondary electronic device 75 includes a virtual display (not illustrated herein) as a part of its communications interface, the secondary electronic device 80 includes a display 130 as a part of its communications interface, and the secondary electronic device 85 includes a navigation panel 140 as a part of its communications interface.

As discussed above, due to the small sizes of the secondary electronic devices 70-80, their respective communications interfaces may be small. For example, the display screen 120 is typically less than about 2 inches in its diagonal dimension (and may be as small as 0.5 to 1.5 inches). The display 130 for the secondary electronic device 80 may be even smaller. As such, if the user 110 is notified of the arrival of every electronic message via the small displays 120 or 130, the displays will quickly become cluttered, and the user 110 may become overwhelmed. On the other hand, the navigation panel 130 of the secondary electronic device 85 (i.e., the automobile) may not necessarily be small, but if every electronic message is communicated via the navigation panel 130, the user 110 may be constantly distracted, which may affect his driving. The same may be said about the secondary electronic device 75 with respect to its virtual display. For these reasons, it is desirable to configure the primary electronic device 60 and/or the secondary electronic devices 70-85 so that they can intelligently sort through the electronic messages, and then they will accordingly determine the manner in which each electronic message is communicated to the user 110 via the respective communications interface of any given secondary electronic.

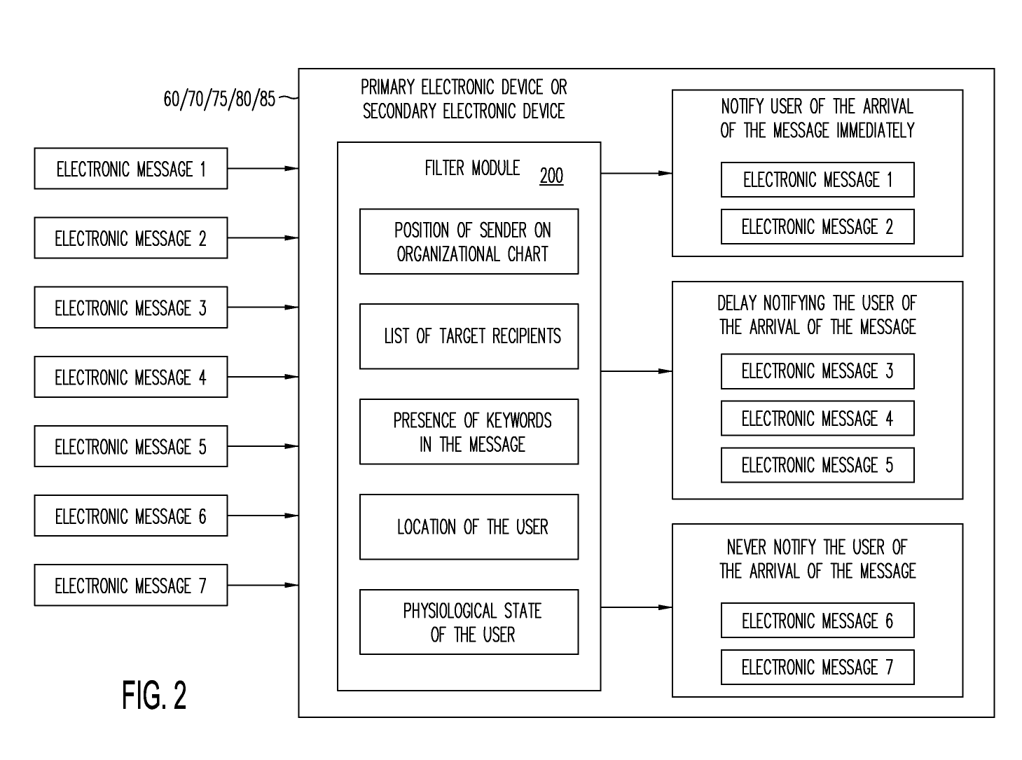

Referring now to FIG. 2, a conceptual block diagram is shown that illustrates the intelligent sorting of the electronic messages and the subsequent treatment (e.g., how the user is notified of their arrival) of these messages according to an embodiment of the present disclosure. It is understood that the “decision making” process discussed here below may be done either by the primary electronic device 60, or by any of the secondary electronic devices 70-85, or both. As is shown in FIG. 2, the primary electronic device 60 has received a plurality of example electronic messages 1-7 and requests to push/forward these messages to the secondary electronic device 70/75/80/85. The primary electronic device 60 or the secondary electronic device 70/75/80/85 according to the present embodiment includes a filter module 200. The filter module 200 may include programming instructions implemented on hardware such as electronic memory. Before the primary electronic device 60 pushes any of the messages 1-7 to the secondary electronic devices 70-85, the filter module 200 executes the programming instructions to apply a list of filter criteria to these messages.

The filter criteria may be based on a plurality of factors. As one example, the filter criteria may include a position of a sender of the electronic message on an organizational chart. For example, the filter module 200 may store therein a copy of the organizational chart describing the names and positions of each employee at the company for which the user 110 works. The filter module 200 may also retrieve such organization chart that is electronically stored elsewhere (e.g., on a remote server). Based on the organizational chart, if the sender of an electronic message is a senior VP or a high level executive or a direct supervisor of the user 110, the filter module 200 may designate the electronic message as sufficiently important and needs to be communicated to the user 110 immediately via the appropriate display (or another suitable communications interface) on the secondary electronic device 70/75/80/85.

As another example, the filter criteria may include a list of target recipients of the electronic message. The filter module 200 may inspect the electronic message to see who the target recipients are. If the target recipient is a wide group, for example if the message is sent to a whole division or section of a company, that typically indicates the message is not important enough for the user 110 to respond right away (e.g., the burden to respond to the message does not lie solely on the user 110). As such, the filter module 200 may designate the message as a message that can be communicated to the user 110 with delay. On the other hand, if the target recipient is only the user 110, that may or may not explicitly indicate the importance of the message, and the filter module 200 may need to apply other filter criteria to the message to further evaluate its importance. In one embodiment, the filter module 200 analyzes the content of the message and/or subject header. For example, the message body or subject header may include the name of the user, which may indicate that the user is expected to respond, even though the message was sent to a wide group. In that case, the group message may be communicated to the user's secondary device(s) and handled as described herein.

As yet another example, the filter criteria may include a presence of one or more predefined keywords or phrases in the electronic message. For example, keywords or phrases such as “urgent”, “immediately”, “important”, “critical”, “crucial”, “ASAP”, “by the end of today”, “close of business” etc., usually convey a high level of importance or urgency. Thus, the filter module 200 scans the electronic message for these keywords or phrases and determines the importance level of the message based on the presence of such keywords or phrases. In some embodiments, the importance level of the message is determined by calculating a term frequency—inverse document frequency (tf-idf) for each keyword or phrase, and if the tf-idf score for one or more keywords that usually convey a high level of importance or urgency is above some threshold the message is determined to be important.

In some embodiments, the filter module 200 may define a threshold, over which the message may be considered sufficiently important to be communicated to the user 110 immediately. For example, the threshold may require two or more appearances of keywords such as “important” or “critical”, but it may require only one appearance of keywords such as “urgent” or “ASAP” or “immediately.” Once the filter module 200 deems that the threshold has been met, it designates the corresponding electronic message as one that should be communicated to the user 110 immediately.

As another example, the filter criteria may also include a location of the user 110 when the electronic message needs to be pushed from the primary electronic device 60 to the secondary electronic device 70-85. For purposes of the present disclosure, the location of the user 110 is assumed to be the same as the location of the primary electronic device 60 or the location of the secondary electronic device 70/75/80/85. A variety of technologies are available to determine the location of the primary electronic device 60 or the secondary electronic device 70/75/80/85. For example, the primary electronic device 60 or the secondary electronic device 70/75/80/85 may have a Global Positioning System (GPS) sensor that allows the GPS satellites to ascertain the location of the user 110. Alternatively, other technologies such as LTE check-in or low energy Bluetooth tracking (e.g., iBeacon®) may be used to determine the location of the user 110 as well, especially if the user 110 is indoors.

If the location determination indicates that the user 110 is currently at a place where he probably does not want to be bothered, such as a place of worship (e.g., church/mosque/synagogue) or a movie theatre, or if it indicates that the user 110 is driving (moving at a high speed), the filter module 200 may decide to delay communicating the electronic messages on the secondary electronic device by default, unless the message is otherwise designated with a high level of importance (e.g., based on its sender or presence of keywords), and then deliver the message upon detection that the user's location has changed to a more appropriate place for message delivery. On the other hand, if the location determination indicates that the user 110 is at work or at home, the filter module 200 may decide to communicate the electronic messages by default.

As yet another example, the filter criteria may further include a physiological state of the user 110. For example, the secondary electronic device 70 and 80 may include sensors that can measure or monitor the physiological conditions of the user 110, such as the user's heart rate, body temperature, blood pressure, etc. If the sensed physiological state of the user 110 indicates that the user is sedentary and awake, the filter module 200 may decide to push through the electronic message and communicate it to the user immediately by default. If the sensed physiological state of the user 110 indicates that the user is exercising or asleep, the filter module 200 may decide to delay the communicating the electronic message via the secondary electronic device by default and then deliver the message when one or more physiological states have changed to a more suitable state.

In some embodiments, the communication of the electronic message to the user 110 via the communications interface of the secondary electronic device may merely include displaying an electronic notification informing the user that the electronic message has arrived and is ready for viewing, but does not include the entire content of the message. In some other embodiments, the communication of the electronic message to the user 110 via the communications interface of the secondary electronic device may include displaying a preview of the message (e.g., a first sentence of the message) instead of, or in addition to, the electronic notification informing the user 110 of the arrival of the electronic message. In other embodiments, the communication of the electronic message to the user 110 via the communications interface of the secondary electronic device may include displaying the electronic message in its entirety.

These examples of the filter criteria discussed above are not an exhaustive list of filter criteria, and other types of filter criteria are not discussed herein in detail for reasons of simplicity. It is understood that the filter criteria may be generated by the filter module 200 automatically based on the programming instructions. In some embodiments, the filter module 200 may also be capable of “learning” how messages should be treated. For example, the filter module 200 may monitor how long it takes for the user to respond to a message from a plurality of senders (i.e., a turnaround time). The filter module 200 may calculate the average turnaround time associated with each sender. Over time, the filter module 200 may recognize that the user 110 always responds very quickly to a particular sender A who is neither a boss of the user 110 nor a high level executive. As such, the filter module 200 may recognize that the sender A is important to the user 110, and it may determine that electronic messages from the sender A should be communicated to the user 110 immediately. As another example, the filter module 200 may learn over time that the user 110 almost never responds to messages while he is exercising. Accordingly, the filter module 200 may decide to delay the communication of all messages by default. Of course, in some embodiments an important sender or the presence of keywords may still override the default decision.

It is also understood that the filter criteria may also be manually specified by the user 110. For example, the user 110 may specify that messages sent by sender X should always be pushed through and communicated to the user immediately, and that messages sent by sender Y should be pushed through and communicated to the user immediately only if the user is not exercising or sleeping, and that messages sent by sender Z should be pushed through and communicated immediately only if it is sent during a specified period of time (e.g., between 9 AM and 5 PM on Monday through Friday).

The user may also specify (or the filter module 200 may automatically determine) that some messages should never be pushed through and/or communicated to the user 110 via the secondary electronic device 70-85 at all. For example, if an electronic message is regarding a routine monthly statement from a bank, or if the electronic message is directed to an advertising offer, etc., these messages may never be communicated via the secondary electronic device (even though they still may appear on the primary electronic device 60). The user may also specify that a message from a particular sender B should never be pushed through and/or communicated on the secondary electronic device.

It is also understood that the filtering of the messages in the manner discussed above may either be automatically performed, or it may be performed in response to a user input. For example, as the user 110 goes into a meeting or goes to bed, he may push a physical or virtual button on the secondary electronic device (or on the primary electronic device) to enter it into a “do not disturb” or “limited communication availability” mode, in which case the filter module 200 becomes activated and will start to screen the electronic messages accordingly. When the meeting is over or when the user 110 wakes up, he may press another button to take the secondary electronic device (or the primary electronic device) out of the “do not disturb” or “limited communication availability” mode. If these modes were automatically entered via the detection that the user has entered into a meeting room (e.g., via micro-location determination) or that the user is asleep, then these modes can also be automatically exited via the detection that the user has left the meeting room or has woken up. In other words, a satisfaction of a predefined condition may activate the filter module 200, and a satisfaction of another predefined condition may deactivate the filter module 200.

Returning to the example illustrated in FIG. 2, the filter module 200 applies the filter criteria discussed above to the electronic messages 1-7 and determines that electronic messages 1 and 2 should be pushed through and communicated to the user 110 immediately, since the electronic message 1 is sent by the boss of the user 110, and the electronic message 2 contains many instances of keywords such as “ASAP”, “urgent”, “immediately”, “by the end of today.” The filter module 200 also determines that electronic messages 3-5 should be not be communicated immediately to the user 110, since the electronic message 3 is sent to a big group of people, the electronic message 4 is sent while the user is sleeping, and the electronic message 5 is sent while the user is at a movie theatre. The electronic messages 3-5 may be eventually communicated to the user 110 only when a predefined condition is met, for example when the user 110 indicates via the secondary electronic device that he is ready to receive more messages now, or if it has been detected that he is awake or outside the movie theatre. The filter module 200 also determines that electronic messages 6 and 7 should never be pushed through and displayed to the user. For example, the electronic message 6 may be sent by a sender whose messages the user 110 wants to block, and the electronic message 7 is a routine message from a bank. In this manner, the user 110 will still receive the electronic messages that are important or urgent without getting his secondary electronic device 70/75/80 cluttered or without getting distracted while the user 110 is driving.

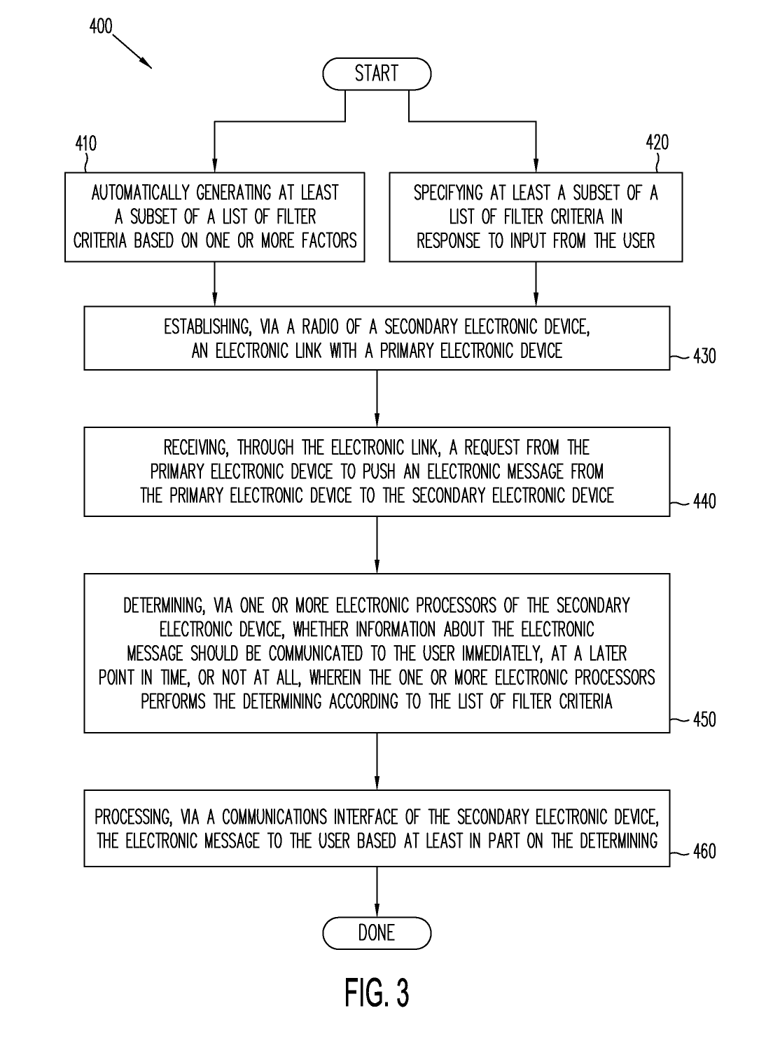

FIG. 3 is a flowchart illustrating a method 400 of selectively notifying a user of a secondary electronic device of messages pushed by a primary electronic device according to embodiments of the present disclosure. In some embodiments, the primary electronic device is a smartphone, a tablet computer, a laptop computer, a desktop computer, or combinations thereof. In some embodiments, the secondary electronic device is a wearable electronic device or an automobile. The wearable electronic device may include, but is not limited to, a smartwatch, a head-mounted display, a fitness wristband, etc.

The method 400 includes a step 410 of automatically generating at least a subset of a list of filter criteria based on one or more factors. For example, the factors may include but are not limited to: a position of a sender of the electronic message on an organizational chart, a list of target recipients of the electronic message, a presence of one or more predefined keywords in the electronic message, a location of the user when the request is received via the electronic link, and a physiological state of the user when the request is received via the electronic link. In some embodiments, the step 430 of automatically generating includes the following steps: calculating average turnaround times in which the user responds to electronic messages from a plurality of senders, respectively; identifying, based on the calculating, one or more senders to which the user responds substantially more quickly than other senders; and stipulating, as a part of the list of filter criteria, that information about electronic messages from the one or more identified senders should be immediately communicated to the user via the communications interface.

The method 400 includes a step 420 of specifying at least a subset of the list of filter criteria in response to input from the user. In some embodiments, either the step 410 or 420, or both, may be performed via a filter module on the secondary electronic device.

The method 400 includes a step 430 of establishing, via a radio of the secondary electronic device, an electronic link with the primary electronic device. In some embodiments, the electronic link may be a wireless link, for example the radio may include a wireless transceiver, a wireless receiver, or a wireless transmitter.

The method 400 includes a step 440 of receiving, through the electronic link, a request from the primary electronic device to push an electronic message from the primary electronic device to the secondary electronic device. In some embodiments, the electronic message includes an email, a text message, or a notification (e.g., an electronic reminder regarding a meeting/appointment).

The method 400 includes a step 450 of determining, via one or more electronic processors of the secondary electronic device, whether information about the electronic message should be communicated to the user immediately, or at a later point in time, or not at all. The one or more electronic processors perform the determining according to the list of filter criteria generated or specified in steps 410 or 420. In some embodiments, the step 450 is performed by the filter module on the secondary electronic device. It is understood that according to step 450, the entire content of the electronic message need not necessarily be communicated to the user. Rather, the communication of the electronic message may include just a notification that the message is available for viewing, or the communication of the electronic message may include just a part of the message.

The method 400 includes a step 460 of processing, via a communications interface of the secondary electronic device, the electronic message to the user based at least in part on the determining step 450. For example, if the determining step 450 determines that the information about the electronic message should be communicated immediately to the user, the step 460 will communicate the electronic message immediately to the user via the communications interface. If the determining step 450 determines that the information about the electronic message should be communicated to the user but with a delay (i.e., not right away), the step 460 will not immediately communicate the electronic message to the user. Rather, the communication to the user will be delayed until a predefined condition is met. In some embodiments, the predefined condition may be met when it has been detected that the user has changed his/her physiological state. In some other embodiments, the predefined condition may be met when the secondary electronic device receives a request from the user to receive all electronic messages, which may be done by the user pushing a hard or soft/virtual button via the communications interface.

Again, it is understood that the communication of the message may include a mere notification that the message is available for viewing, or it may include the content of the message in whole or in part. Sending only a notification about the message may sometimes be necessary when the actual message is too large to be completely sent to the secondary electronic device, but if the message is important (e.g., based on the sender or keywords in the subject line), the user would want to know that the message is available for viewing at least on the primary electronic device. Therefore, the secondary electronic device may display a notification to the user that an important message needs to be viewed on the primary electronic device. It is also understood that in addition to including the different ways of communicating the message to the user, the processing step 460 herein also includes permanently withholding everything about the message, i.e., not sending the message or even a notification about the message.

In some embodiments, the secondary electronic device is the wearable device, and the communications interface includes a display screen having a diagonal size that is less than about 2 inches. In other embodiments, the secondary electronic device is the automobile, and the communications interface includes a navigation panel for the automobile.

It is also understood that additional method steps may be performed before, during, or after the steps 410-460 discussed above. For example, in some embodiments, the method 400 may optionally include a step of putting the secondary electronic device in a “limited communications” mode before the steps 410-460 are performed. In more detail, the secondary electronic device in its default state (i.e., not the “limited communications” mode) may be configured to communicate all electronic messages received from the primary electronic device. Suppose the user is at a meeting or asleep and wishes not to be bothered by most messages but still wishes to respond to important ones, he may then set the secondary electronic device in the “limited communication” mode. In this mode, only important electronic messages (e.g., an urgent email from a president or VP of the company) are communicated immediately to the user via the secondary electronic device, while other routine messages such as the availability of a monthly bank statement or a sale on a web site are delayed and not communicated via the secondary electronic device until the user indicates that the meeting is over. Of course, it is understood that in other embodiments, the “default” state of the secondary electronic device may be a state similar to the “limited communications” mode described above.

It is also understood that one or more of the steps of the method 400 described herein may be omitted, combined, or performed in a different sequence as desired. As an example, the steps 410 or 420 of generating or specifying the list of filter criteria may be performed during or after the step 430 of establishing an electronic link with the primary electronic device.

As discussed above, in some embodiments (such as according to the flowchart shown in FIG. 3), the filter module 200 is implemented on the secondary electronic device 70/75/80/85, and it is the secondary electronic device 70/75/80/85 that determines how and when the electronic messages are displayed to the user 110. In other embodiments, the filter module 200 (or a similar module) may be implemented on the primary electronic device 60, in which case the primary electronic device 60 may determine the manner in which the electronic messages are communicated to the user. This is illustrated as a flowchart in FIG. 4. Similar to FIG. 3, FIG. 4 is a flowchart of an example method 500 for selectively communicating electronic messages to a user, except that the various steps of the method 500 are performed by the primary electronic device of the user.

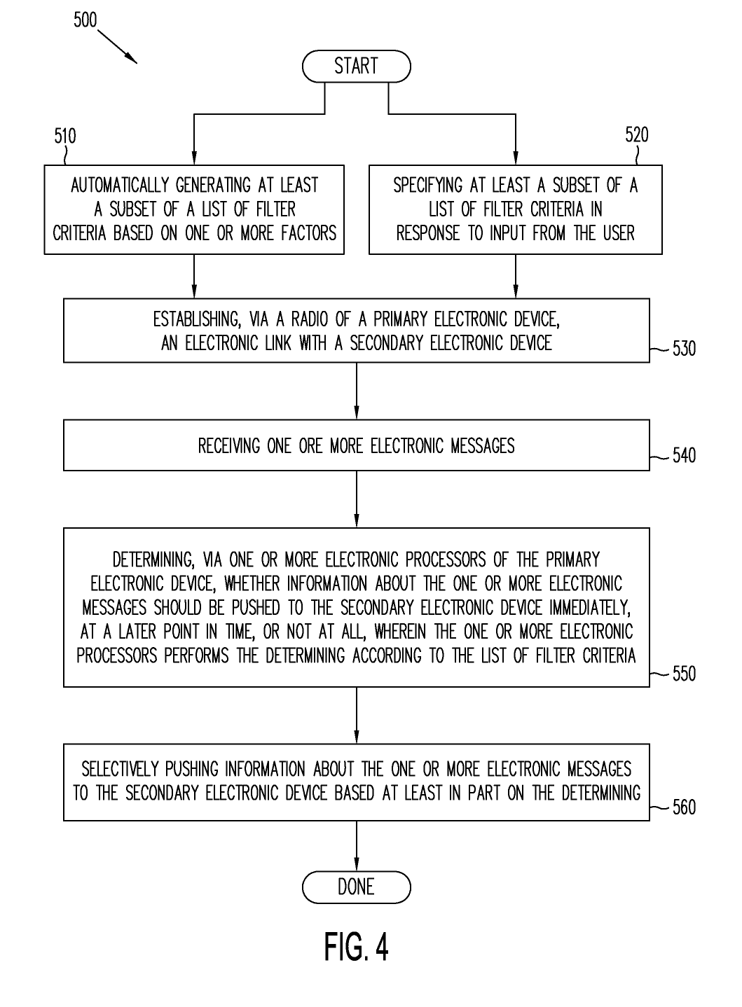

Referring to FIG. 5, the method 500 includes a step 510 of automatically generating at least a subset of a list of filter criteria based on one or more factors and a step 520 of specifying at least a subset of the list of filter criteria in response to input from the user. The steps 510 and 520 are substantially similar to the steps 410 and 420 of the method 400 shown in FIG. 3 and may be performed by a filter module implemented on the primary electronic device 60. Therefore, the details of the steps 510 and 520 will not be repeated herein for reasons of simplicity.

The method 500 includes a step 530 of establishing, via a radio of the primary electronic device, an electronic link with the secondary electronic device. In some embodiments, the electronic link may be a wireless link, for example the radio may include a wireless transceiver, a wireless receiver, or a wireless transmitter.

The method 500 includes a step 540 of receiving one or more electronic messages. The electronic messages may be received via the network 100 of FIG. 1. In some embodiments, the electronic message includes an email, a text message, or a notification (e.g., an electronic reminder regarding a meeting/appointment).

The method 500 includes a step 550 of determining, via one or more electronic processors of the primary electronic device, whether information about the electronic message should be pushed to the secondary electronic device immediately, at a later point in time, or not at all. The one or more electronic processors perform the determining according to the list of filter criteria generated or specified in steps 510 or 520. In some embodiments, the step 550 is performed by the filter module on the primary electronic device. As discussed above with reference to the method 400 in FIG. 3, the information about the electronic message may not necessarily include the message in its entirety, but it may merely include a portion of the message or a mere notification that the message has arrived and is ready for retrieval.

The method 500 includes a step 560 of selectively pushing information about the one or more electronic messages to the secondary electronic device based at least in part on the determining step 550. For example, if the determining step 550 determines that the information about the electronic message should be pushed to the secondary electronic device immediately, the step 560 will push information about the electronic message immediately to the secondary electronic device. If the determining step 550 determines that the information about the electronic message should be pushed to the secondary electronic device but with a delay (i.e., not right away), the step 560 will not immediately push the information about the electronic message to the secondary electronic device. Rather, the pushing of the information about the electronic message will be delayed until a predefined condition is met. In some embodiments, the predefined condition may be met when it has been detected that the user has changed his/her physiological state (e.g., by sensors on the secondary electronic device). In some other embodiments, the predefined condition may be met when the primary device or the secondary electronic device receives a request from the user to receive all electronic messages, which may be done by the user pushing a hard or soft/virtual button on the primary or secondary electronic device. It is also understood that the step 560 may include permanently withholding information about the message, for example the message itself or a notification thereof will not be pushed to the secondary electronic device at all.

It is also understood that additional method steps may be performed before, during, or after the steps 510-560 discussed above. For example, in some embodiments, the method 500 may optionally include a step of detecting that the user has put the secondary electronic device in a “limited communications” mode before the steps 510-560 are performed. In this case, the primary electronic device may delay the pushing of the electronic messages to the secondary electronic device by default, and only messages that are designated as sufficiently important or urgent may be pushed to the secondary electronic device.

It is also understood that one or more of the steps of the method 500 described herein may be omitted, combined, or performed in a different sequence as desired. As an example, the steps 510 or 520 of generating or specifying the list of filter criteria may be performed during or after the step 530 of establishing an electronic link with the secondary electronic device.

It is also understood that in some embodiments, the secondary electronic device 70/75/80/85 may be communicatively coupled to the network 100 and does not require the primary electronic device 60 to receive the electronic messages. In these embodiments, the filter module 200 may still be used to perform the screening of the electronic messages and determine the manner in which they are communicated to the user 110 according to the various aspects of the present disclosure discussed above. It is also understood that in some other embodiments, not all steps discussed in FIGS. 3-4 need to be performed by a single device, be it the primary electronic device 60 or any of the secondary electronic devices 70-85. Rather, some of the steps may be performed by the primary electronic device 60, while some of the other steps may be performed by the secondary electronic devices 70-85.

FIG. 5 is a block diagram of a computer system 600 suitable for implementing various methods and devices described herein, for example, the various method steps of the methods 400 and 500. In various implementations, the devices capable of performing the steps may comprise a network communications device (e.g., mobile cellular phone, laptop, personal computer, tablet computer, wearable electronic devices, etc.), a network computing device (e.g., a network server, a computer processor, an electronic communications interface, etc.), or another suitable device. Accordingly, it should be appreciated that the devices capable of implementing the method 400 and 500 may be implemented as the computer system 600 in a manner as follows.

In accordance with various embodiments of the present disclosure, the computer system 600, such as a smartphone, a tablet computer, or a wearable electronic device, includes a bus component 602 or other communication mechanisms for communicating information, which interconnects subsystems and components, such as a computer processing component 604 (e.g., processor, micro-controller, digital signal processor (DSP), etc.), system memory component 606 (e.g., RAM), static storage component 608 (e.g., ROM), disk drive component 610 (e.g., magnetic or optical), network interface component 612 (e.g., modem or Ethernet card), display component 614 (e.g., cathode ray tube (CRT) or liquid crystal display (LCD)), input component 616 (e.g., keyboard), cursor control component 618 (e.g., mouse or trackball), and image capture component 620 (e.g., analog or digital camera). In one implementation, disk drive component 610 may comprise a database having one or more disk drive components.

In accordance with embodiments of the present disclosure, computer system 600 performs specific operations by the processor 604 executing one or more sequences of one or more instructions contained in system memory component 606. Such instructions may be read into system memory component 606 from another computer readable medium, such as static storage component 608 or disk drive component 610. In other embodiments, hard-wired circuitry may be used in place of (or in combination with) software instructions to implement the present disclosure.

Logic may be encoded in a computer readable medium, which may refer to any medium that participates in providing instructions to the processor 604 for execution. Such a medium may take many forms, including but not limited to, non-volatile media and volatile media. In one embodiment, the computer readable medium is non-transitory. In various implementations, non-volatile media includes optical or magnetic disks, such as disk drive component 610, and volatile media includes dynamic memory, such as system memory component 606. In one aspect, data and information related to execution instructions may be transmitted to computer system 600 via a transmission media, such as in the form of acoustic or light waves, including those generated during radio wave and infrared data communications. In various implementations, transmission media may include coaxial cables, copper wire, and fiber optics, including wires that comprise bus 602.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 630 (e.g., a communications network, such as a LAN, WLAN, PTSN, and/or various other wired or wireless networks, including telecommunications, mobile, and cellular phone networks) may perform instruction sequences to practice the present disclosure in coordination with one another.

Computer system 600 may transmit and receive messages, data, information and instructions, including one or more programs (i.e., application code) through communication link 630 and communication interface 612. Received program code may be executed by computer processor 604 as received and/or stored in disk drive component 610 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

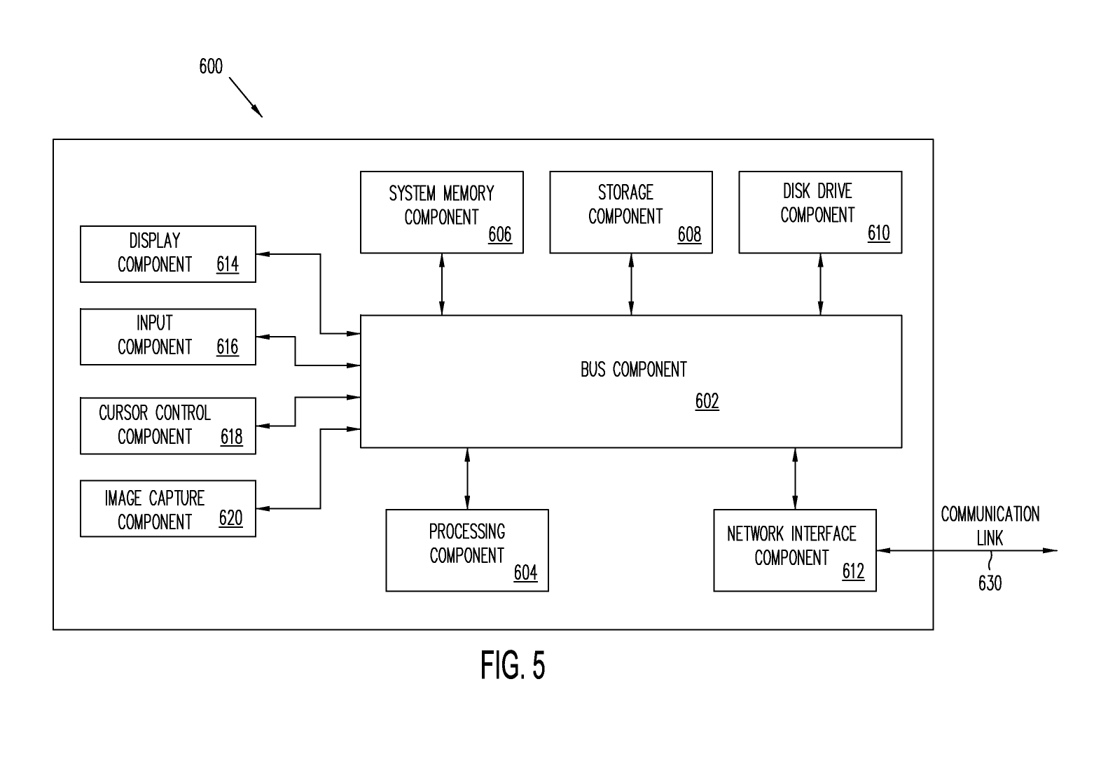

FIG. 6 illustrates an example cloud-based computing architecture 700, which may also be used to implement various aspects of the present disclosure. The cloud-based computing architecture 700 includes a mobile device 704 and a computer 702, both connected to a computer network 706 (e.g., the Internet or an intranet). In one example, a consumer has the mobile device 704, which is configured to run software to provide an app with certain functionalities. In some embodiments, the mobile device 704 is the primary electronic device 60 discussed above with reference to FIG. 1. In other embodiments, the mobile device 704 is the secondary electronic device 70/75/80/85 discussed above with reference to FIG. 1. In yet other embodiments, the mobile device 704 includes both the primary electronic device 60 and the secondary electronics 70-85 discussed above with reference to FIG. 1.

The mobile device 704 is in communication with cloud-based resources 708, which may include one or more computers, such as server computers, with adequate memory resources to handle requests from a variety of buyers. A given embodiment may divide up the functionality between the mobile device 704 and the cloud-based resources 708 in any appropriate manner. For example, an app on mobile device 704 may perform basic input/output interactions with the buyer, but a majority of the processing and caching may be performed by the cloud-based resources 708. However, other divisions of responsibility are also possible in various embodiments.

The cloud-based computing architecture 700 also includes the personal computer 702 in communication with the cloud-based resources 708. In one example, a participating user may access information from the cloud-based resources 708 by logging on to user account at computer 702.

It is understood that the various components of cloud-based computing architecture 700 are shown as examples only. For instance, a given user may access the cloud-based resources 708 by a number of devices, not all of the devices being mobile devices. Furthermore, the cloud-based resources 708 may accommodate many users in various embodiments.

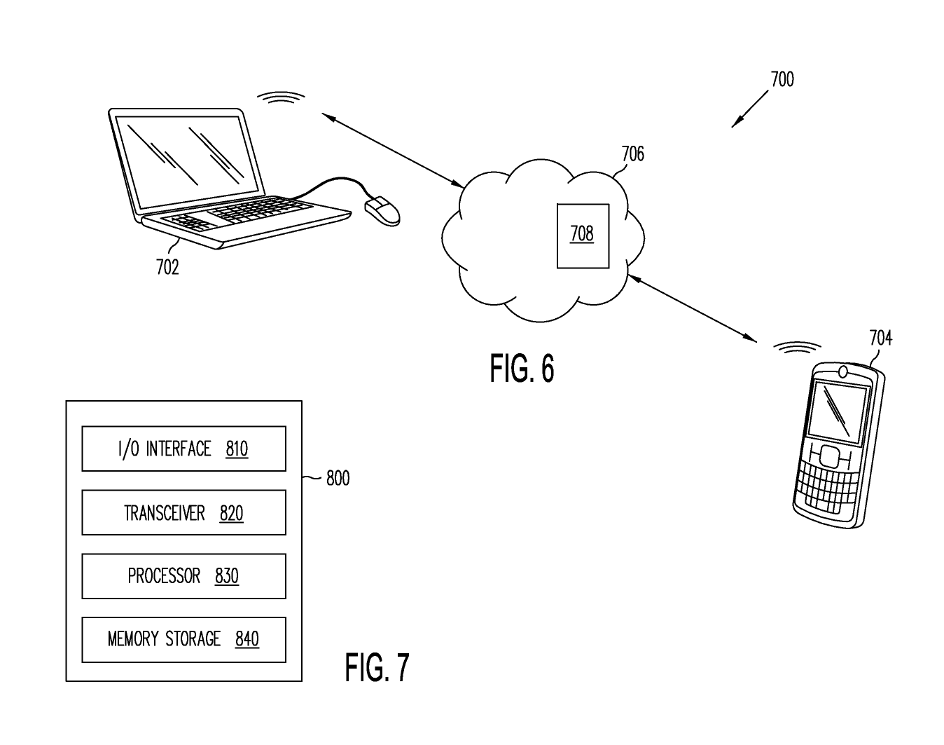

FIG. 7 is a simplified block diagram of an electronic system 800 for facilitating electronic commerce. For example, the electronic system 800 may be used to perform the screening of the electronic messages and selectively communicating them to the user according to the various aspects of the present disclosure discussed herein. In some embodiments, the electronic system 800 may include one or more computer servers or portable electronic devices (such as the primary or secondary electronic devices discussed above) operable to perform the methods 400 or 500 of FIGS. 3-4.

The electronic system 800 includes an input/output interface module 810. The interface module 810 is operable to receive an input from an external entity and communicate an output to the external entity. In an embodiment, the input/output interface module 810 includes a visual display unit. The input/output interface module 810 may also include physical and/or virtual buttons, keyboards, mouse, track balls, speakers, microphones, light-sensors, light-emitting diodes (LEDs), communications ports (such as USB or HDMI ports), joy-sticks, image-capture devices (for example cameras), etc.

The electronic system 800 includes a transceiver module 820. The transceiver module 820 contains various electronic circuitry components configured to conduct telecommunications with one or more external devices. The electronic circuitry components allow the transceiver module 820 to conduct telecommunications in one or more of the wired or wireless telecommunications protocols, including communications protocols such as IEEE 802.11 (WiFi), IEEE 802.15 (Bluetooth), GSM, CDMA, LTE, WIMAX, DLNA, HDMI, etc. In some embodiments, the transceiver module 820 includes antennas, filters, low-noise amplifiers, digital-to-analog (DAC) converters, analog-to-digital (ADC) converters, and transceivers. The transceiver module 820 may further include circuitry components such as mixers, amplifiers, oscillators, phase-locked loops (PLLs), and/or filters. Some of these electronic circuitry components may be integrated into a single discrete device or an integrated circuit (IC) chip.

The electronic system 800 also includes a computer processor module 830 that is operable to execute computer instructions, for example the programming instructions for the filter module 200 discussed above. The computer processor module 830 may contain one or more central processing units (CPUs), graphics processing units (GPUs), or digital signal processors (DSPs), which may each be implemented using various digital circuit blocks (including logic gates such as AND, OR, NAND, NOR, XOR gates, etc.) along with certain software code.

The electronic system 800 includes a memory storage module 840. The memory storage module 840 may contain various forms of digital memory, such as hard disks, FLASH, SRAM, DRAM, ROM, EPROM, memory chips or cartridges, etc. Computer programming code may be permanently or temporarily stored in the memory storage module 840, for example. The processor module 830 may be used to execute the computer programming code stored in the memory storage module 840. In some embodiments, the memory storage module 840 also contains one or more program modules, for example the filter module 200 configured to screen electronic messages according to the present disclosure.

It should be appreciated that like reference numerals are used to identify like elements illustrated in one or more of the figures, wherein these labeled figures are for purposes of illustrating embodiments of the present disclosure and not for purposes of limiting the same.

One aspect of the present disclosure involves an electronic apparatus. The electronic apparatus includes: a radio configured to receive and transmit electronic signals; a memory storage configured to store programming instructions; and one or more electronic processors configured to execute the programming instructions to perform the following steps: establishing, via the radio, an electronic link with an external secondary electronic device, wherein the external secondary electronic device includes a wearable electronic device or an automobile; receiving one or more electronic messages; determining, according to a list of filter criteria, whether information about the one or more electronic messages should be pushed to the external secondary electronic device immediately, at a later point in time, or not at all; and selectively pushing the information about the one or more electronic messages to the external secondary electronic device based at least in part on the determining.

Another aspect of the present disclosure involves a system. The system includes: a primary electronic device; and a secondary electronic device located external to, and communicatively coupled with, the primary electronic device; wherein the primary electronic device includes a radio configured to receive and transmit electronic signals, a memory storage configured to store programming instructions, and one or more electronic processors configured to execute the programming instructions to perform the following steps: establishing, via the radio, an electronic link with the secondary electronic device; receiving one or more electronic messages; determining, according to a list of filter criteria, whether information about the one or more electronic messages should be pushed to the secondary electronic device immediately, at a later point in time, or not at all; and selectively pushing the information about the one or more electronic messages to the secondary electronic device based at least in part on the determining.

One more aspect of the present disclosure involves a method of selectively notifying a user of a secondary electronic device of messages. The method includes: establishing an electronic link between a primary electronic device and a secondary electronic device of a user, wherein the secondary electronic device is located external to the primary electronic device; receiving, by the primary electronic device, one or more electronic messages; determining, according to a list of filter criteria, whether information about the one or more electronic messages should be pushed by the primary electronic device to the secondary electronic device immediately, at a later point in time, or not at all; and selectively pushing the information about the one or more electronic messages to the secondary electronic device based at least in part on the determining.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. An electronic apparatus, comprising:
a radio configured to receive and transmit electronic signals;
a memory storage configured to store programming instructions; and
one or more electronic processors configured to execute the programming instructions to perform the following steps:
establishing, via the radio, an electronic link with an external secondary electronic device, wherein the external secondary electronic device includes a wearable electronic device or an automobile;
receiving one or more electronic messages;
determining, according to a list of filter criteria, whether information about the one or more electronic messages should be pushed to the external secondary electronic device immediately, at a later point in time, or not at all; and
selectively pushing the information about the one or more electronic messages to the external secondary electronic device based at least in part on the determining.

2. The electronic apparatus of claim 1, wherein the electronic apparatus is a smartphone or a tablet computer.

3. The electronic apparatus of claim 1, wherein the selectively pushing comprises: delaying pushing of the information about the one or more electronic messages to the external secondary electronic device until a predefined condition is met.

4. The electronic apparatus of claim 1, wherein the steps further comprise, before the determining: receiving at least a subset of the list of filter criteria from the external secondary electronic device.

5. The electronic apparatus of claim 1, wherein the steps further comprise, before the determining:
automatically generating at least a subset of the list of filter criteria based on one or more factors selected from the group consisting of: a position of a sender of the one or more electronic messages on an organizational chart, a list of target recipients of the one or more electronic messages, a presence of one or more predefined keywords in the one or more electronic messages, a location of a user of the electronic apparatus, and a physiological state of the user.

6. The electronic apparatus of claim 5, wherein the automatically generating comprises:
calculating average turnaround times in which a user of the electronic apparatus responds to electronic messages from a plurality of senders, respectively;
identifying, based on the calculating, one or more senders to which the user responds substantially more quickly than other senders; and
stipulating, as a part of the list of filter criteria, that information about electronic messages from the one or more identified senders should be immediately pushed to the external secondary electronic device.

7. The electronic apparatus of claim 1, wherein the steps further comprise, before the determining: specifying at least a subset of the list of filter criteria in response to input from a user of the electronic apparatus.

8. A system, comprising:
a primary electronic device; and
a secondary electronic device located external to, and communicatively coupled with, the primary electronic device;
wherein the primary electronic device includes a radio configured to receive and transmit electronic signals, a memory storage configured to store programming instructions, and one or more electronic processors configured to execute the programming instructions to perform the following steps:
establishing, via the radio, an electronic link with the secondary electronic device;
receiving one or more electronic messages;
determining, according to a list of filter criteria, whether information about the one or more electronic messages should be pushed to the secondary electronic device immediately, at a later point in time, or not at all; and
selectively pushing the information about the one or more electronic messages to the secondary electronic device based at least in part on the determining.

9. The system of claim 8, wherein:
the primary electronic device is a smartphone or a tablet computer; and
the secondary electronic device is a wearable electronic device or an automobile.

10. The system of claim 8, wherein the selectively pushing comprises: delaying pushing of the information about the one or more electronic messages to the secondary electronic device until a predefined condition is met.

11. The system of claim 8, wherein the steps further comprise, before the determining: receiving at least a subset of the list of filter criteria from the secondary electronic device.

12. The system of claim 8, wherein the steps further comprise, before the determining:
automatically generating at least a subset of the list of filter criteria based on one or more factors selected from the group consisting of: a position of a sender of the one or more electronic messages on an organizational chart, a list of target recipients of the one or more electronic messages, a presence of one or more predefined keywords in the one or more electronic messages, a location of a user of the primary electronic device and the secondary electronic device, and a physiological state of the user.

13. The system of claim 12, wherein the automatically generating comprises:
calculating average turnaround times in which a user of the electronic apparatus responds to electronic messages from a plurality of senders, respectively;
identifying, based on the calculating, one or more senders to which the user responds substantially more quickly than other senders; and
stipulating, as a part of the list of filter criteria, that information about electronic messages from the one or more identified senders should be immediately pushed to the external secondary electronic device.

14. The system of claim 8, wherein the steps further comprise, before the determining: specifying at least a subset of the list of filter criteria in response to input from a user of the electronic apparatus.

15. A method, comprising:
establishing an electronic link between a primary electronic device and a secondary electronic device of a user, wherein the secondary electronic device is located external to the primary electronic device;
receiving, by the primary electronic device, one or more electronic messages;
determining, according to a list of filter criteria, whether information about the one or more electronic messages should be pushed by the primary electronic device to the secondary electronic device immediately, at a later point in time, or not at all; and
selectively pushing the information about the one or more electronic messages to the secondary electronic device based at least in part on the determining.

16. The method of claim 15, wherein:
the primary electronic device is a smartphone or a tablet computer; and
the secondary electronic device is a wearable electronic device or an automobile.

17. The method of claim 15, wherein the selectively pushing comprises: delaying pushing of the information about the one or more electronic messages to the secondary electronic device until a predefined condition is met.

18. The method of claim 15, further comprising, before the determining: receiving at least a subset of the list of filter criteria from the secondary electronic device.

19. The method of claim 15, wherein the steps further comprise, before the determining:
automatically generating at least a subset of the list of filter criteria based on one or more factors selected from the group consisting of: a position of a sender of the one or more electronic messages on an organizational chart, a list of target recipients of the one or more electronic messages, a presence of one or more predefined keywords in the one or more electronic messages, a location of the user, and a physiological state of the user.

20. The method of claim 19, wherein the automatically generating comprises:
calculating average turnaround times in which the user responds to electronic messages from a plurality of senders, respectively;
identifying, based on the calculating, one or more senders to which the user responds substantially more quickly than other senders; and
stipulating, as a part of the list of filter criteria, that information about electronic messages from the one or more identified senders should be immediately pushed to the secondary electronic device.

21. The method of claim 15, wherein the steps further comprise, before the determining: specifying at least a subset of the list of filter criteria in response to input from the user.
